(19) United States
(12) Patent Application Publication
(10) Pub. No.: US 2013/0286028 A1
(43) Pub. Date: Oct. 31, 2013

(54) ADDRESS GENERATOR OF IMAGE PROCESSING DEVICE AND OPERATING METHOD OF ADDRESS GENERATOR

(71) Applicant: SAMSUNG ELECTRONICS CO., LTD., Suwon-si (KR)

(72) Inventor: Jae Young HUR, Hwasung-City (KR)

(73) Assignee: SAMSUNG ELECTRONICS CO., LTD., Suwon-si (KR)

(21) Appl. No.: 13/785,907

(22) Filed: Mar. 5, 2013

(30) Foreign Application Priority Data
Apr. 30, 2012 (KR) 10-2012-0045722

(51) Int. Cl. G09G 5/39

(52) U.S. Cl. CPC G09G 5/39
USPC 345/540

(57) ABSTRACT

A method of operating an address generator configured to map an image onto a plurality of memories via an interleaving includes detecting information associated with the image and the interleaving; selecting an address mapping scheme according to the detection result; and mapping the image onto the plurality of memories according to the selected address mapping scheme.

### CROSS-REFERENCE TO RELATED APPLICATIONS

This application claims priority under 35 U.S.C. §119 to Korean Patent Application No. 10-2012-0045722 filed Apr. 30, 2012, in the Korean Intellectual Property Office, the disclosure of which is incorporated by reference herein.

### BACKGROUND

1. Technical Field

Exemplary embodiments of the inventive concept relate to an address generator of an image processing device and an operating method of the address generator.

2. Discussion of Related Art

In recent years, the use of portable devices such as smart phones, tablets, notebook computers, and the like have been increasing rapidly. Portable devices typically have a display unit to display images. These images may have a high definition format that requires the device to include additional memory capacity or several memories. However, it can be difficult for a portable device to efficiently manage these high definition images when the images are stored on the several memories.

### SUMMARY

According to an exemplary embodiment of the inventive concept, a method of operating an address generator which maps an image onto a plurality of memories via an interleaving includes detecting information associated with the image and the interleaving; selecting an address mapping scheme according to the detection result; and mapping the image onto the plurality of memories according to the selected address mapping scheme. The interleaving may refer to mapping a portion of the image onto one of the memories and another portion of the image onto another one of the memories.

The selecting of the address mapping scheme may include selecting one of two or more address mapping schemes.

The two or more address mapping schemes may include a first scheme in which the image is sequentially mapped onto the plurality of memories according to a size of the interleaving. The size of the interleaving may refer to the size of the portions of the image that are mapped onto each one of the different memories.

The two or more address mapping schemes may further include a second scheme in which a part of the image is mapped onto the plurality of memories according to the first scheme and the remainder of the image is mapped onto the plurality of memories in an order different from the first scheme.

The mapping may include using memory mapping bits of memory addresses to determine a selected one of the plurality of memories to map portions of the image onto.

The selecting of the address mapping scheme may include selecting a first scheme, in which the memory mapping bits sequentially increase according to an interleaving granularity, if the information associated with the image and the interleaving satisfies a first condition.

The selecting of the address mapping scheme may further include selecting a second scheme, in which the memory mapping bits sequentially increase according to an interleaving granularity and the memory mapping bits corresponding to the some interleaving granularities are adjusted, if the information associated with the image and the interleaving satisfies a second condition.

For example, the memory mapping bit or set of memory mapping bits with the lowest value may map to a first one of the memories, the memory mapping bit or set of memory mapping bits with the next highest value may map to the sequentially next one of the memories (e.g., the 2^{nd}), etc. Most significant bits of the memory mapping bits corresponding to the some interleaving granularities may be inverted.

The image may be divided into a matrix format according to the interleaving granularity, and the some interleaving granularities may correspond to even rows of the matrix format.

The image may be divided in a matrix format according to the interleaving granularity, and the some interleaving granularities may correspond to even columns of the matrix format.

The information associated with the image and the interleaving may include a size of the image, a size of each of a plurality of tiles obtained by dividing the image, an interleaving granularity, and the number of the plurality of memories.

According to an exemplary embodiment of the inventive concept, an address generator of an image processing device includes an address mapping unit which receives information of an image and outputs first memory addresses corresponding to a plurality of memories based on the input information of the image; a memory mapping bit adjusting unit which receives the memory addresses and outputs second memory addresses by adjusting memory mapping bits selecting one of the plurality of memories among the input memory addresses; a checking unit which receives the information of the image and information of interleaving for dispersedly storing the image at the plurality of memories and outputs a selection signal based on the input information of the image and the information of interleaving; and a multiplexer which outputs either the first memory addresses or the second memory addresses in response to the selection signal.

The memory mapping bit adjusting unit may invert a most significant bit of the memory mapping bits.

The information of the image may include a size of the image and a size of each of tiles generated by dividing the image.

The information of interleaving may include an interleaving granularity and the number of the plurality of memories.

According to an exemplary embodiment of the inventive concept, a method of storing an image into a plurality of memories includes determining a number of portions a row or column of the image is to be divided into, wherein each portion is a tile of the image, selecting one of a first address mapping scheme and a second address mapping scheme based on the determined numbered, dividing the entire image into units of the tiles, and storing each tile into a selected one of the memories based on the selected address mapping scheme.

When the first address mapping scheme is selected, the storing may include copying each tile in each row or column of the image into a different sequential one of the memories. When the second address scheme is selected, the storing may include copying each tile in each odd row or column of the image into a different sequential one of the memories and copying each tile in each even row or column of the image into a non-sequential one of the memories. Each tile may have an associated address, and the storing may include selecting one of the memories based on a mapping bit of the address and copying the tile into the selected memory. Values of the mapping bits of at least two of the tiles may be different from one another, and each different value may correspond to a different one of the memories.

### BRIEF DESCRIPTION OF THE FIGURES

Embodiments of the inventive concept will become apparent from the following description with reference to the following figures, wherein like reference numerals refer to like parts throughout the various figures unless otherwise specified, and wherein

FIG. 1 is a block diagram schematically illustrating an image processing device according to an exemplary embodiment of the inventive concept.

FIG. 2 is a diagram schematically illustrating exemplary image data processed by masters 121 to 12k in FIG. 1.

FIG. 3 is a flowchart illustrating a method of operating address generators according to an exemplary embodiment of the inventive concept.

FIG. 4 is a diagram illustrating an example where masters access a part of image data.

FIG. 5 is a diagram illustrating an address mapping scheme according to an exemplary embodiment of the inventive concept.

FIG. 6 is a diagram illustrating an address mapping scheme according to an exemplary embodiment of the inventive concept.

FIG. 7 is a table illustrating an exemplary memory mapping of TM and MF address mapping schemes according to a tile number variable.

FIG. 8 is a graph illustrating exemplary metrics of TM and MF address mapping schemes according to a tile number variable.

FIG. 9 is a table illustrating exemplary conditions for selecting a TM address mapping scheme and an MF address mapping scheme.

FIG. 10 is a diagram illustrating an MF address mapping method executed when an interleaving granularity is larger than a tile size.

FIG. 11 is a diagram illustrating an MF address mapping method executed when an interleaving granularity is smaller than a tile size.

FIG. 12 is a block diagram schematically illustrating an address generator according to an exemplary embodiment of the inventive concept.

FIG. 13 is a block diagram schematically illustrating an image processing device according to an exemplary embodiment of the inventive concept.

FIG. 14 is a block diagram schematically illustrating a multimedia device according to an exemplary embodiment of the inventive concept.

### DETAILED DESCRIPTION

Exemplary embodiments of the inventive concept will be described in detail with reference to the accompanying drawings. The inventive concepts, however, may be embodied in various different forms, and should not be construed as being limited only to the illustrated embodiments. In the drawings, the sizes and relative sizes of layers and regions may be exaggerated for clarity.

As used herein, the singular forms “a”, “an” and “the” are intended to include the plural forms as well, unless the context clearly indicates otherwise. It will be understood that when an element or layer is referred to as being “on”, “connected to”, “coupled to”, or “adjacent to” another element or layer, it can be directly on, connected, coupled, or adjacent to the other element or layer, or intervening elements or layers may be present.

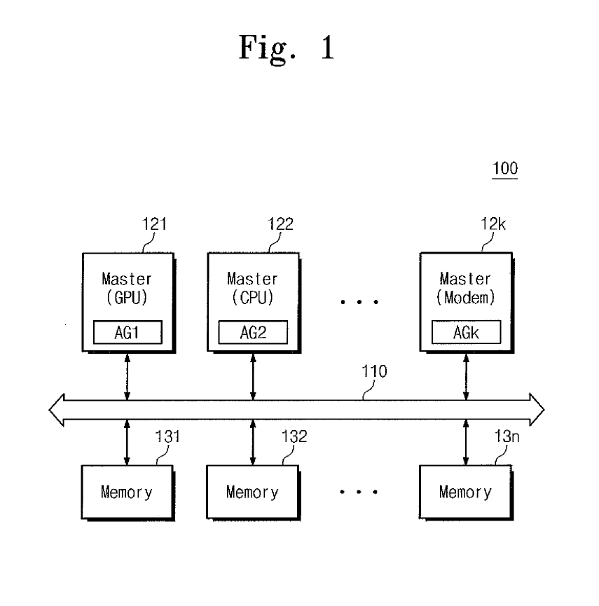

FIG. 1 is a block diagram schematically illustrating an image processing device according to an exemplary embodiment of the inventive concept. Referring to

FIG. 1, an image processing device 100 includes a bus 110, a plurality of masters 121 to 12k, and a plurality of memories 131 to 13n.

The bus 110 may provide a communication channel between elements of the image processing device 100. For example, data from the memories 131 to 13n can be output to the masters 121 to 12k across the bus 110, and results calculated by the masters 121 to 12k may be transmitted across the bus 110 for storage in the memories 131 to 13n.

The masters 121 to 12k may control slaves of the image processing device 100, for example, the memories 131 to 13n. The masters 121 to 12k may exchange data with one another. The masters 121 to 12k may process input data. For example, the masters 121 to 12k may include a graphic processing unit (GPU), a central processing unit (CPU), an image signal processor (ISP), a modem, and the like.

The masters 121 to 12k may include address generators AG1 to AGk, respectively. The address generators AG1 to AGk may be configured to generate addresses (e.g., addresses of the memories 131 to 13n) under the control of the masters 121 to 12k. The address generators AGI to AGk may be formed by hardware, software, or combination of hardware and software.

The masters 121 to 12k may control image data based on locations of pixels. For example, the masters 121 to 12k may process image data according to coordinate values of pixels of image data.

Image data may be dispersedly stored at the memories 131 to 13n. For example, image data may be stored at the memories 131 to 13n in an interleaving manner. That is, addresses based on locations of pixels of image data processed by the masters 121 to 12k may be different from memory addresses of image data stored at the memories 131 to 13n. For example, a portion of an image of the image data at one location or a range of locations within the image may be stored at one address within one of the memories and another portion of the image at another location or another range of locations within the image may be stored at another address within the same one memory or a different one of the memories.

The address generators AG1 to AGk may receive addresses (hereinafter, referred to as pixel addresses) processed by the masters 121 to 12k, and may generate addresses (hereinafter, referred to as memory addresses) of the memories 131 to 13n. For example, the pixel addresses may identify the portions of the image and the memory addresses may identity the locations of the memories in which the portions are to be copied or stored into.

The masters 121 to 12k, the memories 131 to 13n, and the bus 110 may be integrated to form a system-on-chip (SoC).

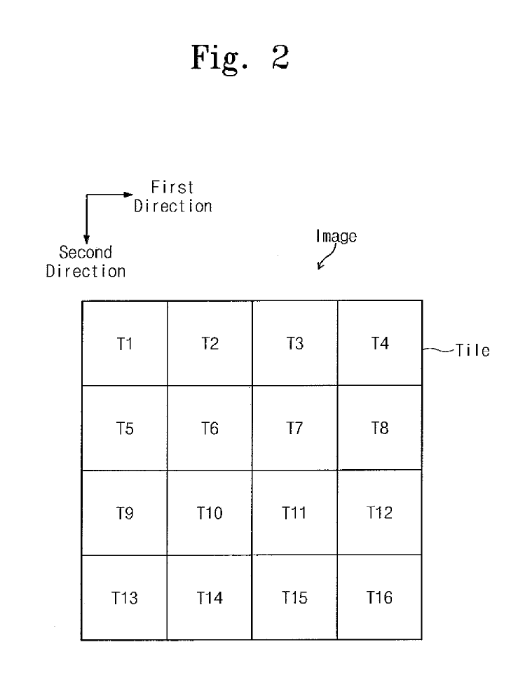

FIG. 2 is a diagram schematically illustrating exemplary image data processed by masters 121 to 12k in FIG. 1. Referring to FIGS. 1 and 2, masters 121 to 12k may partition image data into a plurality of tiles T1 to T16. The masters 121 to 12k may access image data stored at memories 131 to 13n in units of tiles. For example, the masters 121 to 12k may write image data to the memories 131 to 13n in tile units, and may read image data from the memories 131 to 13n in tile units. For example, a master could write data to one or more tiles T1 to T16 of a memory or read data from one or more tiles of a memory.

Image data may be stored at the memories 131 to 13n in an interleaving manner Image data may be divided by an interleaving granularity to be dispersedly stored at the memories 131 to 13n. In an exemplary embodiment, the interleaving granularity may be equal to a size of a tile. For ease of description, it is assumed that the interleaving granularity is equal to a size of a tile. However, embodiments of the invention are not limited thereto, as the granularity may be greater than the size of a single tile (e.g., 2 tiles, 2.5 tiles, etc.) or less than the size of a single tile (e.g., 0.25 tiles, 0.5 tiles, etc).

Image data corresponding to one interleaving granularity (for example one tile) may be stored in the same memory. Memory addresses may be assigned to image data corresponding to the interleaving granularity (e.g., one tile) along a first direction and a second direction. For example, image data of a first row of a first tile T1 may be assigned with sequential addresses along the first direction. Addresses of image data of a last column of the first row and image data of a first column of a second row of the image tile T1 may be sequential.

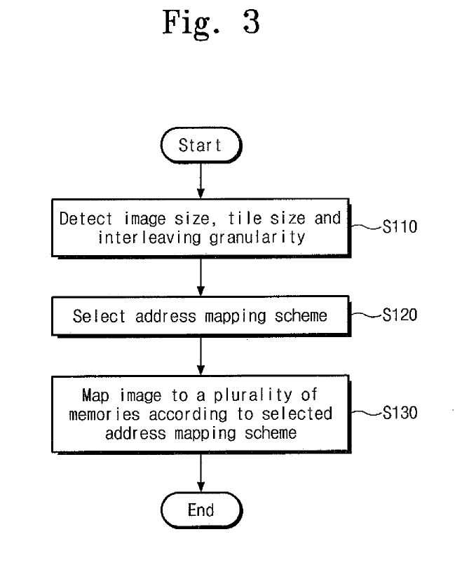

FIG. 3 is a flowchart illustrating a method of operating address generators according to an exemplary embodiment of the inventive concept. Referring to FIGS. 1 to 3, address generators AG1 to AGk detect an image size, a tile size, and an interleaving granularity processed by an image processing device 100 (S110).

The address generators AG1 to AGk select an address mapping scheme according to the detection result (S120).

The address generators AG1 to AGk map images onto memories according to the selected address mapping scheme (S130). For example, the address generators AG1 to AGk may convert image addresses (e.g., pixel addresses) into memory addresses.

In an exemplary embodiment of the inventive concept, the image and tile sizes processed by the image processing device 100 are determined according to the specification of masters 121 to 12k. The interleaving granularity processed at the image processing device 100 and the number of the memories 131 to 13n may be determined according to the specification of the image processing device 100.

When the masters 121 to 12k of the image processing device 100 are changed (e.g., due to a design modification), the interleaving granularity processed at the image processing device 100 and the number of the memories 131 to 13n may be maintained, and the image and tile sizes processed by the image processing device 100 may be modified. When the masters 121 to 12k of the image processing device 100 are maintained and the interleaving granularity and the number of the memories 131 to 13n are changed (e.g., due to a design modification), the image and tile sizes may be maintained, and the interleaving granularity and memories 131 to 13k, in which interleaved image data is stored, may be changed.

Although the image size, the tile size (or, a tile number), the interleaving granularity, or the number of memories 131 to 13k is changed, the address generators AG1 to AGk may select optimized load balancing to map images onto memories. Thus, the image processing device 100 may operate with an efficient operating speed.

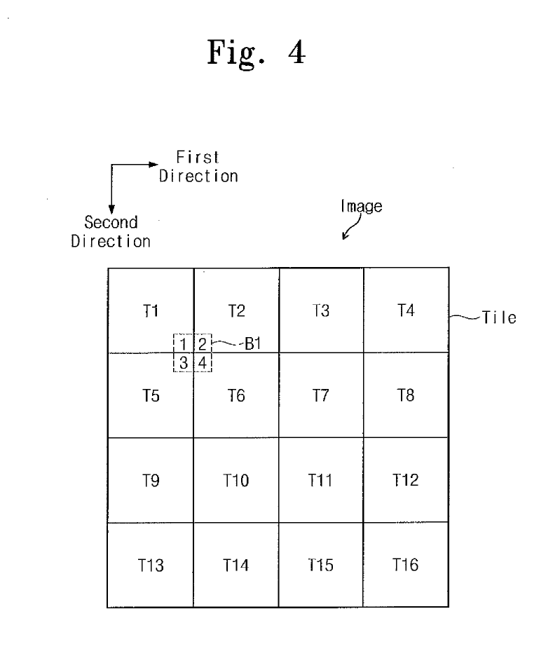

FIG. 4 is a diagram illustrating an example where masters access a part of image data. Referring to FIGS. 1 and 4, at least one of masters 121 to 12k access a part B1 of image data. For example, at least one master reads the partial data B1 of the image data.

At least one master may process image data based on locations of pixels. The at least one master may read image data in units of pixel rows.

The partial data B1 is partially included in four tiles T1, T2, T5, and T6. When the at least one master reads a first row of the partial data B1 (e.g., a row of pixels), an address generator AG generates memory addresses of a first row of data 1 in the first tile T1 and memory addresses of a first row of data 2 in the second tile T2. When the at least one master reads a second row (e.g., a row of pixels), corresponding to the fifth and sixth tiles T5 and T6, of the partial data B1, the address generator AG generates memory addresses of a second row of data 3 in the fifth tile T5 and memory addresses of a second row of data 4 in the sixth tile T6.

For example, when the at least one master reads the partial data B, the address generator AG generates memory addresses of memories at which the tiles T1, T2, T5, and T6 are stored, respectively. When tiles T1, T2, T5, and T6 are stored within the same memory, the partial data B1 is read out from one memory. That is, load may be focused on one memory. When tiles T1, T2, T5, and T6 are stored within different memories, the partial data B1 is read out from different memories. When the at least one master reads the partial data B1, the efficiency of load balancing may vary according to the number of memories which the partial data B1 is interleaved or address mapped onto.

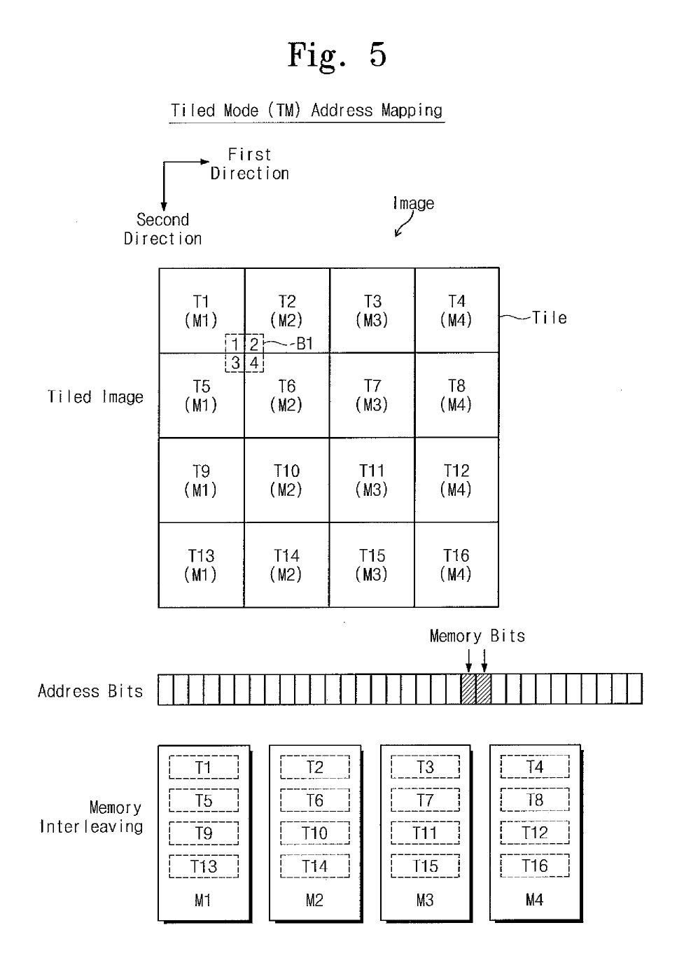

FIG. 5 is a diagram illustrating an address mapping scheme according to an exemplary embodiment of the inventive concept. Referring to FIGS. 1 and 5, an address mapping scheme is a tiled mode (TM) address mapping scheme. In an exemplary embodiment, image data is interleaved onto four memories M1 to M4. However, the inventive concept is not limited to any particular number of memories, as the image data may be interleaved onto a number of memories less than or greater than four.

With the TM address mapping scheme, tiles at each row are sequentially mapped onto memories M1 to M4 along a first direction. First to fourth tiles T1 to T4 are mapped onto the first to fourth memories M1 to M4, respectively. 5^{th} to 8^{th} tiles T5 to T8 are mapped onto the first to fourth memories M1 to M4, respectively. 9^{th} to 12^{th} tiles T9 to T12 are mapped onto the first to fourth memories M1 to M4, respectively. 13^{th} to 16^{th} T13 to T16 T12 may be mapped onto the first to fourth memories M1 to M4, respectively.

In an exemplary embodiment, memory addresses are 32-bit addresses. However, embodiments of the inventive concept are not limited to a memory address of any particular size, as 32 is merely provided as an example for ease of understanding the disclosure. In an exemplary embodiment, two bits (e.g., 11^{th} and 12^{th} bits) of a 32-bit memory address are assigned for mapping of memories M1 to M4. If an i^{th} bit is used for mapping, 2ⁱ-bit image data may be assigned to successive addresses of one memory. If a 11^{th} bit is used for mapping, 2¹¹-bit image data may be assigned to successive addresses of one memory. Below, bits, assigned for mapping of memories M1 to M4, from among memory addresses may be referred to as memory mapping bits.

When memory mapping bits are ‘00’, memory addresses may correspond to the first memory M1. When memory mapping bits are ‘01’, memory addresses may correspond to the second memory M2. When memory mapping bits are ‘10’, memory addresses may correspond to the third memory M3. When memory mapping bits are ‘11’, memory addresses may correspond to the fourth memory M4. The inventive concept is not limited to locating the memory mapping bits at any particular position within the memory address. For example, the memory mapping bits could be the 5^{th} and 6^{th} bits, the 8^{th} and 9^{th} bits, etc. Further, there may be only a single memory mapping bit when two memories are present or more than three memory mapping bits when more than four memories are present.

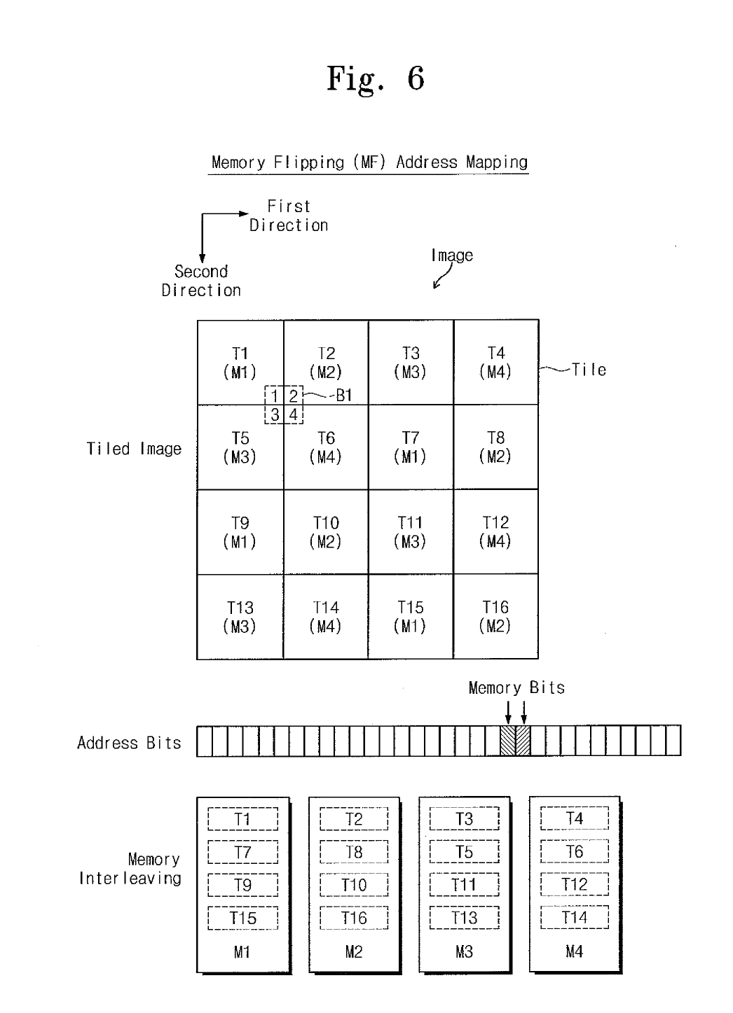

FIG. 6 is a diagram illustrating an address mapping scheme according to an exemplary embodiment of the inventive concept. Referring to FIGS. 1, 5, and 6, an address mapping scheme is a memory flipping (MF) address mapping scheme. In an exemplary embodiment, image data is interleaved onto four memories M1 to M4.

With the MF address mapping scheme, memory mapping bits of a part of a row or a column are converted depending upon a TM address mapping scheme. In an exemplary embodiment, memory mapping bits of memory addresses of an even row are converted. A most significant bit of memory mapping bits may be inverted.

When memory mapping bits of the TM address mapping are ‘00’, memory mapping bits of the MF address mapping may be ‘10’ and correspond to a third memory M3. When memory mapping bits of the TM address mapping are ‘01’, memory mapping bits of the MF address mapping may be ‘11’ and correspond to a fourth memory M4. When memory mapping bits of the TM address mapping are ‘10’, memory mapping bits of the MF address mapping may be ‘00’ and correspond to a first memory M1. When memory mapping bits of the TM address mapping are ‘11’ , memory mapping bits of the MF address mapping may be ‘01’ and correspond to a second memory M2.

It is understood from FIGS. 5 and 6 that memories onto tiles of even rows of image data are mapped onto are changed. For example, while FIG. 5 shows that the seventh tile T7 and eighth tile T8 in the second row are mapped onto the third memory M3 and fourth memory M4, respectively, FIG. 6 shows that the seventh tile T7 and eighth tile T8 are mapped onto the first memory M1 and second memory M2, respectively. In FIG. 5, partial data B1 may be read from the first and second memories M1 and M2. In FIG. 6, the partial data B1 may be dispersedly read from the first to fourth memories Ml to M4. The number of memories from which the partial data B1 is read may vary according to which of the TM address mapping scheme and the MF address mapping scheme is used. The more the number of memories from which the partial data B1 is read, the larger the effect of load balancing.

Address generators AG1 to AGk according to an exemplary embodiment of the inventive concept may select one, having an optimized load balancing effect, from among TM and MF address mapping schemes according to an image size, a tile size (or, a tile number), an interleaving granularity, and the number of memories 131 to 13n.

A tile number variable T and a metric may be defined for comparison between load balancing effects of the TM and MF address mapping schemes. The tile number variable T and the metric may be expressed by the following formulas 1 and 2, respectively.

$$\begin{matrix}T = Im gH \text{/} TileH & [ Formula 1 ] \\ Metric = {Σ}_{i} S ( i ) \text{/} TNT , S ( i ) = {Σ}_{j} Compare ( j ) & [ Formula 2 ]\end{matrix}$$

In the formula 2, TNT may indicate a total number of tiles, and a function Compare(j) may indicate a function for comparing surrounding tiles. An image variable ImgH may indicate a horizontal size of an image, and a tile constant TileH may indicate a horizontal size of a tile. That is, the tile constant T may indicate the number of tiles to which an image is partitioned in a horizontal direction. A variable i or j may indicate tiles. The function Compare( j) may return ‘0’ when compared tiles are stored at the same memory, and may return ‘1’ when compared tiles are stored at different memories. That is, a function S(i) may indicate the number of tiles, stored at a memory different from a specific tile, from among tiles adjacent to the specific tile. The Metric may indicate a ratio that adjacent tiles of image data are stored at different memories. The load balancing may be more efficient the larger the Metric.

In an exemplary embodiment, values of the function S(i) corresponding to respective tiles may be T1:2, T2:4, T3:3, T4:4, T5:6, T6:4, T7:3, T8:4, and T9:2. In FIG. 5, the Metric may be 3.55. In FIG. 6, values of the function S(i) corresponding to respective tiles may be T1:3, T2:4, T3:2, T4:4, T5:6, T6:4, T7:2, T8:4, and T9:3. In FIG. 6, the Metric may be 3.55. The above values of the function S(i) and the Metric are examples, as they may have different values in different embodiments,

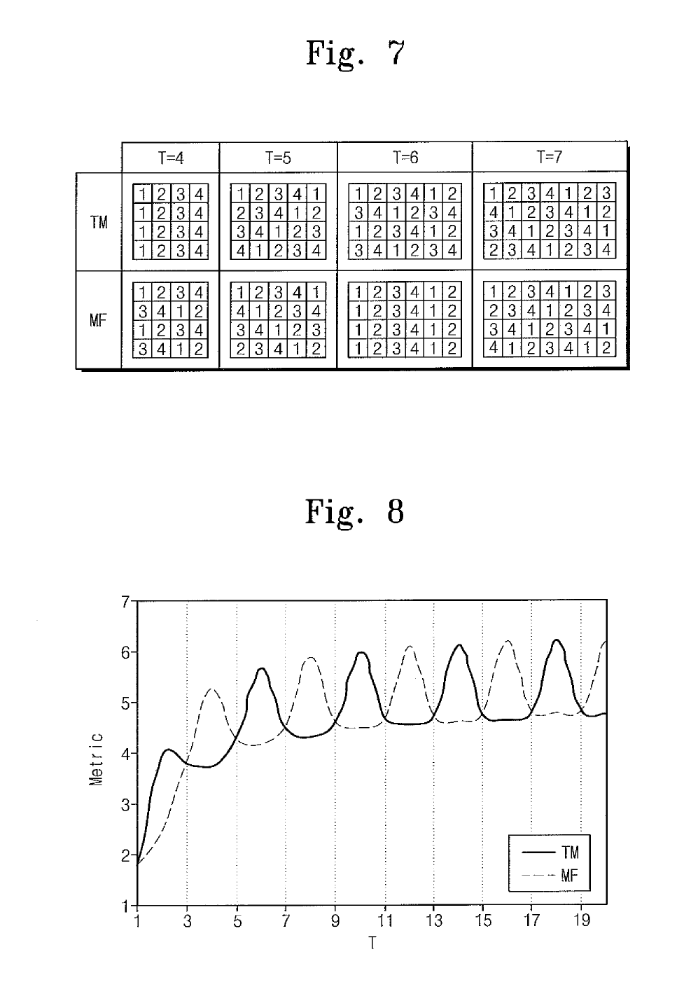

FIG. 7 is an exemplary table illustrating memory mapping of TM and MF address mapping schemes according to a tile number variable. Referring to FIG. 7, it is assumed that image data is interleaved onto four memories. A reference numeral of each tile may indicate a memory to be mapped. With an MF address mapping scheme, a most significant bit of memory mapping bits may be inverted corresponding to tiles at an even row among memory addresses generated according to a TM address mapping scheme.

When a tile number variable T is 4, the TM address mapping scheme may have a low metric since tiles at each row are mapped onto memories in the same order, and the MF address mapping scheme may have a high metric since tiles at each row are mapped onto memories to be mixed. When a tile number variable T is 6, the MF address mapping scheme may have a low metric since tiles at each row are mapped onto memories in the same order, and the TM address mapping scheme may have a high metric since tiles at each row are mapped onto memories to be mixed.

FIG. 8 is an exemplary graph illustrating metrics of TM and MF address mapping schemes according to a tile number variable. In FIG. 8, a horizontal axis may indicate a tile number variable T, and a vertical axis may indicate a metric. Referring to FIG. 8, TM address mapping and MF address mapping may have opposite metrics according to a tile number variable T. When a metric of the TM address mapping increases, a metric of the MF address mapping may decrease. When a metric of the TM address mapping decreases, a metric of the MF address mapping may increase.

A period where a metric of the MF address mapping is higher than a metric of the TM address mapping may be calculated from FIG. 8. The period may be expressed by the following formula 3.

$$NM \times ( n - \frac{1}{4} ) \leq T \leq NM \times ( n + \frac{1}{4} ) \qquad [ Formula 3 ]$$

In the formula 3, a variable NM may indicate the number of memories, and a variable n may indicate a positive integer. If a value of a tile number variable T satisfies the formula 3, a metric of the MF address mapping may be higher than a metric of the TM address mapping. That is, a load balancing effect of the MF address mapping scheme may be larger than that of the TM address mapping scheme.

In accordance with the formula 3, when the number of memories is 4, a value of a tile number variable T indicating excellent MF address mapping may be 3 to 5, 7 to 9, 11 to 13, 15 to 17, 19 to 21, and the like.

When a tile size is equal to an interleaving granularity and an image processing device 100 satisfies the formula 3, address generators AG1 to AGk may perform the MF address mapping with respect to even rows, based on the TM address mapping. When no image processing device 100 satisfies the formula 3, the address generators AG1 to AGk may perform the TM address mapping.

As illustrated in FIGS. 7 and 8, the TM address mapping and the MF address mapping may have different load balancing effects according to a tile number variable T. The address generators AG1 to AGk according to an exemplary embodiment of the inventive concept selects one, having an optimized load balancing effect, from among the TM address mapping scheme and the MF address mapping scheme in view of various conditions including a tile number variable T.

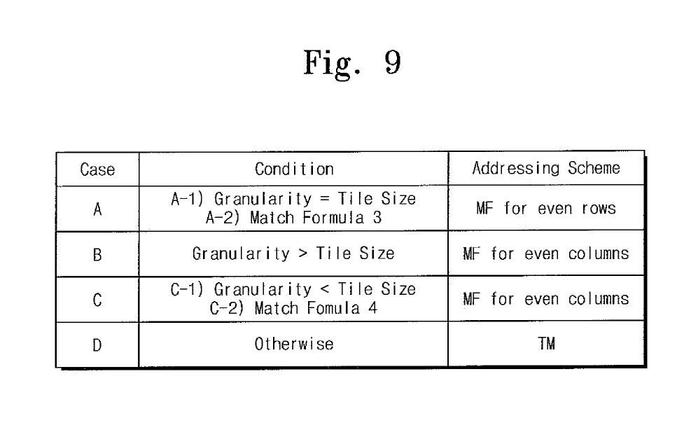

FIG. 9 is an exemplary table illustrating conditions for selecting one of a TM address mapping scheme and an MF address mapping scheme. Referring to FIG. 9, one may consider not only the case where an interleaving granularity is equal to a tile size, but also the case where an interleaving granularity is not equal to a tile size. In an exemplary embodiment, when an interleaving granularity is larger than a tile size, it may be a whole number multiple of the tile size. When an interleaving granularity is smaller than a tile size, the tile size may be a whole number multiple of the interleaving granularity or a fraction of the tile size.

At a case A, an interleaving granularity is equal to a tile size. As described with reference to FIGS. 7 and 8, when an interleaving granularity is equal to a tile size and if formula 3 is satisfied, TM address mapping may be performed. In this case, MF address mapping may be performed with respect to even rows. When an interleaving granularity is not equal to a tile size, TM address mapping may be performed (case D).

At a case B, an interleaving granularity is larger than a tile size. If an interleaving granularity is larger than a tile size, several tiles may belong to one interleaving granularity. If the TM address mapping is performed, tiles belonging to one interleaving granularity may be mapped onto the same memory. That is, adjacent tiles may be mapped onto the same memory. Thus, in the event that an interleaving granularity is larger than a tile size, the TM address mapping may be performed. In this case, the MF address mapping may be performed with respect to tiles at even columns.

At a case C, an interleaving granularity is smaller than a tile size. If an interleaving granularity is smaller than a tile size, several interleaving granularities may be included in one tile. For example, several interleaving granularities may be arranged in a line along a first direction at one tile. The following formula 4 may be used to select one of a TM address mapping and an MF address mapping in connection with the case C.

$$NM \times ( n - \frac{1}{4} ) \leq ( \frac{tile\_size}{granularity} ) \leq NM \times ( n + \frac{1}{4} ) \qquad [ Formula 4 ]$$

In a case that uses formula 3, one of TM address mapping and MF address mapping may be selected according to a ratio of a tile size to an image size. In a case that uses formula 4, one of TM address mapping and MF address mapping may be selected according to a ratio of an interleaving granularity to a tile size. Since several interleaving granularities are included in one tile like a case where several tiles are included in one image in the formula 3, an image size of the formula 3 may be replaced with a tile size and a tile size may be replaced with an interleaving granularity.

If an interleaving granularity is smaller than a tile size and the formula 4 is satisfied, the TM address mapping may be performed. The MF address mapping may be performed with respect to tiles at even columns.

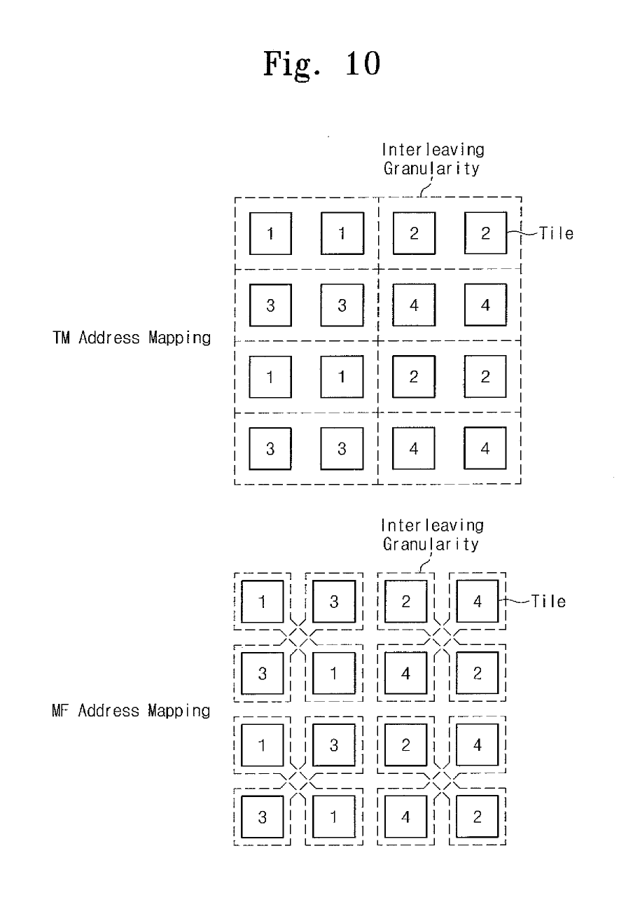

FIG. 10 is an exemplary diagram illustrating an MF address mapping method executed when an interleaving granularity is larger than a tile size. In FIG. 10, reference numerals may indicate memories to be mapped. One interleaving granularity may include two tiles. For example, in one interleaving granularity, two tiles may be disposed in a line along a first direction.

If TM address mapping is performed, memories may be sequentially mapped onto interleaving granularities. Thus, tiles in one interleaving granularity may be mapped onto the same memory, and a metric may be lowered.

If MF address mapping is performed with respect to tiles at even columns, tiles belonging to one interleaving granularity may be mapped onto the same memory. The tiles may be mixed not to be adjacent to one another. Thus, a metric may be improved, and a load balancing efficiency may be improved.

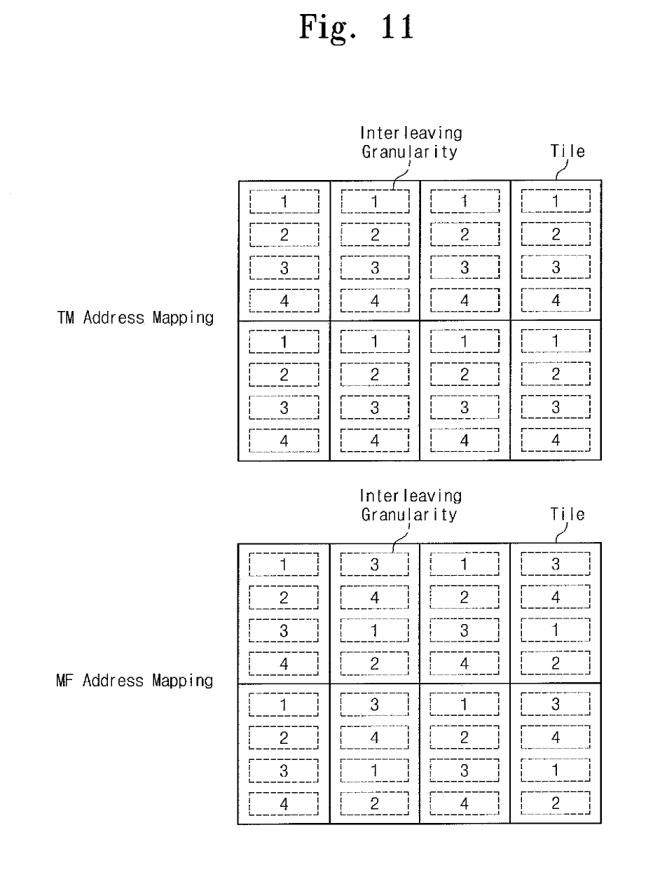

FIG. 11 is an exemplary diagram illustrating an MF address mapping method executed when an interleaving granularity is smaller than a tile size. In FIG. 11, reference numerals may indicate memories to be mapped. One tile may include four interleaving granularities. For example, in one tile, four interleaving granularities may be disposed in a line along a second direction.

If TM address mapping is performed, memories may be sequentially mapped onto interleaving granularities. Thus, interleaving granularities of adjacent tiles may be mapped onto the same memory, and a metric may be lowered.

If MF address mapping is performed with respect to tiles at even columns, interleaving granularities of adjacent tiles may be mixed not to be adjacent to one another. Thus, a metric may be improved, and a load balancing efficiency may be improved.

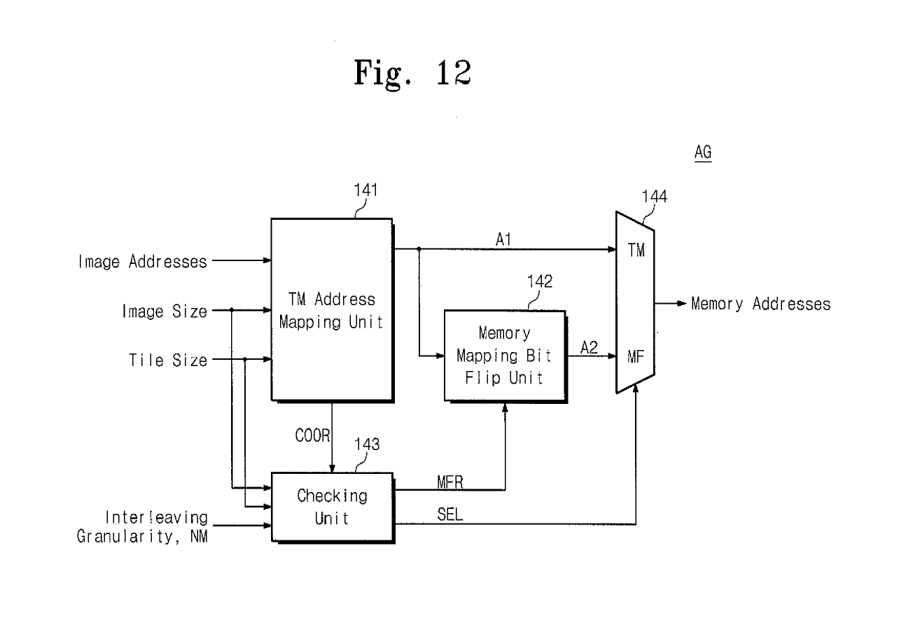

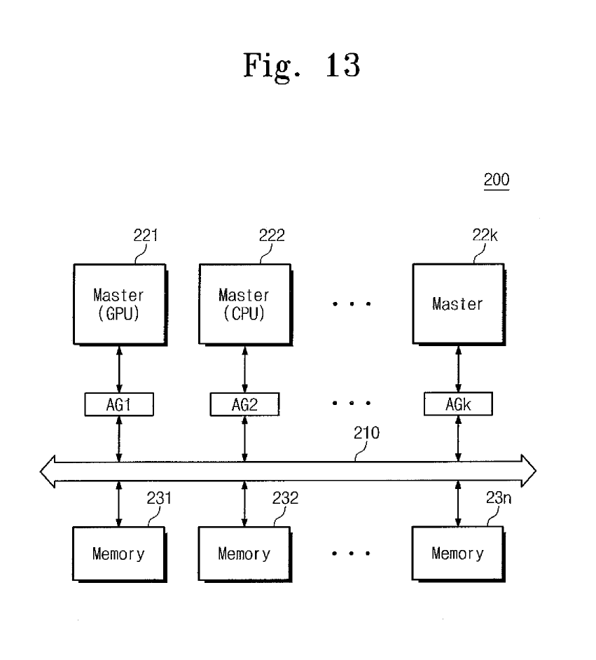

FIG. 12 is a block diagram schematically illustrating an address generator according to an exemplary embodiment of the inventive concept. Referring to FIGS. 1 and 12, an address generator AG includes a TM address mapping unit 141, a memory mapping bit flip unit 142, a checking unit 143, and a multiplexer 144.

The TM address mapping unit 141 receives image addresses, an image size, and a tile size, which are provided from at least one of a plurality of masters 121 12k. The TM address mapping unit 141 performs TM address mapping based on input information to output first memory addresses A1. The TM address mapping unit 141 may calculate coordinates COOR of a selected image region based on the image addresses, the image size, and the tile size. The coordinates COOR of the selected image region may be provided to the checking unit 143.

The memory mapping bit flip unit 142 may convert memory mapping bits of the first memory addresses A1 from the TM address mapping unit 141. For example, the memory mapping bit flip unit 142 may invert a most significant bit of memory mapping bits. The memory mapping bit flip unit 142 receives range information MFR from the checking unit 143, and may convert memory mapping bits according to the range information MFR. The memory mapping bit flip unit 142 may convert memory mapping bits of addresses, indicated by the range information MFR, from among the first memory addresses A1. The memory mapping bit flip unit 142 may output the conversion result as second memory addresses A2.

The checking unit 143 may receive an image size, a tile size, an interleaving granularity, and the number of memories NM. The interleaving granularity and the number of memories NM may be information previously provided to the checking unit 143. The interleaving granularity and the number of memories NM may be stored at a nonvolatile memory (e.g., ROM), and may be transferred to the checking unit 143. The checking unit 143 may calculate addresses, convert a memory mapping bit, from among the first addresses A1, based on the image size, the tile size, the interleaving granularity, and the number of memories NM. The checking unit 143 may output the range information MFR and a selection signal SEL based on the calculation result.

The multiplexer 144 receives the first and second addresses A1 and A2 from the TM address mapping unit 141 and the memory mapping bit flip unit 142, respectively. The multiplexer 144 selects the first memory addresses or the second memory addresses in response to the selection signal SEL.

When a selected image region is accessed, the TM address mapping unit 141 may output the first addresses A1 corresponding to the selected image region. The memory mapping bit flip unit 142 may convert memory mapping bits of addresses, indicated by the range information MFR, from among the first memory addresses A1. The multiplexer 144 may select either the first memory addresses or the second memory addresses in response to the selection signal SEL. For example, the multiplexer 144 may output the first memory addresses A1 with respect to a region, not corresponding to the range information MRF, from among the selected image region. The multiplexer 144 may output the second memory addresses A2 with respect to a region, corresponding to the range information MRF, from among the selected image region.

FIG. 13 is a block diagram schematically illustrating an image processing device according to an exemplary embodiment of the inventive concept. Referring to FIG. 13, an image processing unit 200 includes a bus 210, a plurality of masters 221 to 22k, a plurality of address generators AG1 to AGk, and a plurality of memories 231 to 23n. Compared with the image processing device 100 in FIG. 1, the address generators AG1 to AGk in FIG. 13 are located outside the masters 221 to 22k, respectively. The address generators AG1 to AGk may be formed of hardware, software, or combination of hardware and software.

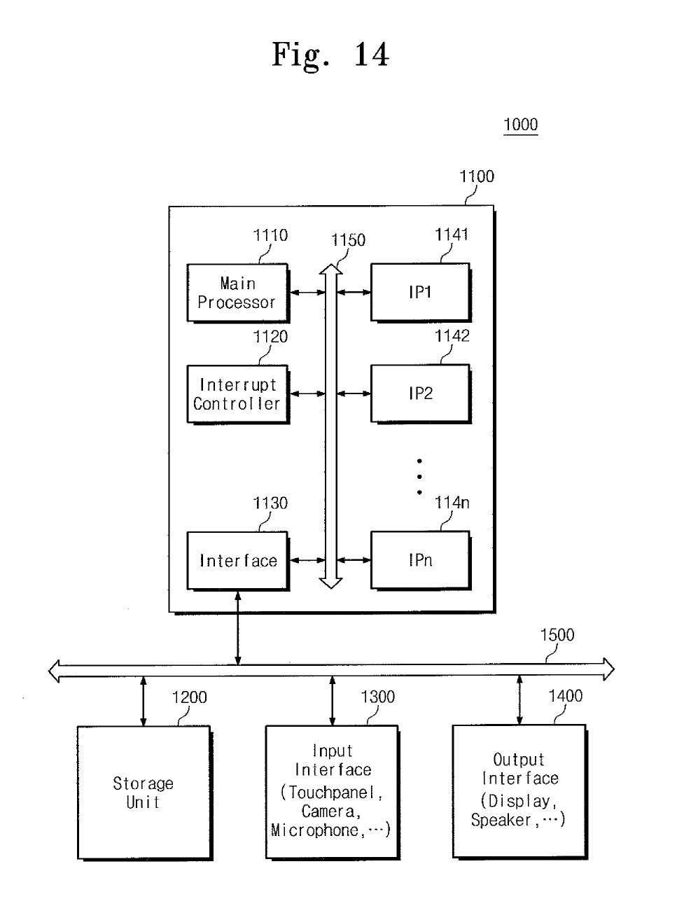

FIG. 14 is a block diagram schematically illustrating a multimedia device according to an exemplary embodiment of the inventive concept. Referring to FIG. 14, a multimedia device 1000 includes an application processor 1100, a storage unit 1200, an input interface 1300, an output interface 1400, and a bus 1500.

The application processor 1100 may be configured to control an overall operation of the multimedia device 1000. The application processor 1100 may be formed as a system-on-chip.

The application processor 1100 includes a main processor 1110, an interrupt controller 1120, an interface 1130, a plurality of intelligent property (IP) blocks 1141 to 114n, and an internal bus 1150. In an exemplary embodiment, an IP block (e.g., an IP core) is a reusable unit of logic, a cell, or chip layout design that is the intellectual property of one party.

The main processor 1110 may be a core of the application processor 1100. The interrupt controller 1120 may manage interrupts generated within the application processor 1100 and report the generated interrupts to the main processor 1110.

The interface 1130 may relay data between the application processor 1100 and external elements. The interface 1130 may relay data that enables the application processor 1100 to control external elements. The interface 1130 may include an interface for controlling the storage unit 1200, an interface for controlling the input and output interfaces 1300 and 1400, and the like. The interface 1130 may include a Joint Test Action Group (JTAG) interface, a Test Interface Controller (TIC) interface, memory interface, an Integrated Drive Electronics (IDE) interface, a Universal Serial Bus (USB) interface, a Serial Peripheral Interface (SPI), an audio interface, a video interface, and the like.

The IP blocks 1141 to 114n may perform specific functions, respectively. For example, the IP blocks 1141 to 114n may include an internal memory, a graphic processing unit (GPU), a modem, a sound controller, a security module, and the like.

The internal bus 1150 may provide a communications channel between internal elements of the application processor 1100. For example, the internal bus 1150 may include an Advanced Microcontroller Bus Architecture (AMBA) bus. The internal bus 1150 may include an Advanced High Performance Bus (AMBA AHB) or an Advanced Peripheral Bus (AMBA APB). The internal bus 1150 may correspond to the bus 110 in FIG. 1.

The main processor 1100 and at least two or more blocks of the IP blocks 1141 to 114n may correspond to masters 121 to 12k which are described with reference to FIG. 1. Address generators AG1 to AGk, corresponding to the masters 121 to 12k, from among the main processor 1100 and the IP blocks 1141 to 114n, may be formed of hardware, software, or combination of hardware and software.

The masters 121 to 12k may store image data at memories of the IP blocks 1141 to 114n in an interleaving manner. The masters 121 to 12k may dispersedly store image data according to a TM address mapping scheme or an MF address mapping scheme.

Masters 121 to 12k of the main processor 1100 and the IP blocks 1141 to 114n may include internal memories. Image data may be stored in the internal memories of the masters 121 to 12k in an interleaving manner.

Image data may be stored in internal memories of the application processor 1100 and external memories (e.g., the storage unit 1200 or separate memories) in an interleaving manner.

The storage unit 1200 may be configured to communicate with other elements of the multimedia device 1000 via the bus 1500. The storage unit 1200 may store data processed by the application processor 1100.

The input interface 1300 may include various devices for receiving signals from an external device. The input interface 1300 may include a keyboard, a key pad, a button, a touch panel, a touch screen, a touch ball, a touch pad, a camera including an image sensor, a microphone, a gyroscope sensor, a vibration sensor, a data port for wire input, an antenna for wireless input, and the like.

The output interface 1400 may include various devices for outputting a signal to an external device. The output interface 1400 may include a liquid crystal display (LCD), an Organic Light Emitting Diode (OLED) display device, an Active Matrix OLED (AMODEL) display device, an LED, a speaker, a motor, a data port for wire output, an antenna for wireless output, and the like.

The multimedia device 1000 may automatically edit an image acquired via an image sensor of the input interface 1300 to display it through a display unit of the output interface 1400. The multimedia device 1000 may support a video conference, and may provide a video conference service having an improved quality of service.

The multimedia device 1000 may include a mobile multimedia device such as a smart phone, a tablet, a digital camera, a digital camcorder, a notebook computer, and the like or a non-portable multimedia device such as a smart television, a desktop computer, and the like.

While the inventive concepts have been described with reference to exemplary embodiments, various changes and modifications may be made in these embodiments without departing from the spirit and scope of the present invention.

What is claimed is:

1. A method of operating an address generator configured to map an image onto a plurality of memories via an interleaving, the method comprising:
detecting information associated with the image and the interleaving;
selecting an address mapping scheme according to the detection result; and
mapping the image onto the plurality of memories according to the selected address mapping scheme.

2. The method of claim 1, wherein the selecting an address mapping scheme includes selecting one of two or more address mapping schemes.

3. The method of claim 2, wherein the two or more address mapping schemes includes a first scheme in which the image is sequentially mapped onto the plurality of memories according to a size of the interleaving.

4. The method of claim 3, wherein the two or more address mapping schemes further includes a second scheme in which a part of the image is mapped onto the plurality of memories according to the first scheme and the remainder of the image is mapped onto the plurality of memories in an order different from the first scheme.

5. The method of claim 1, wherein the mapping comprises using memory mapping bits of memory addresses to determine a selected one of the plurality of memories to map portions of the image onto.

6. The method of claim 5, wherein the selecting an address mapping scheme includes selecting a first scheme, in which the memory mapping bits sequentially increase according to an interleaving granularity, if the information associated with the image and the interleaving satisfies a first condition.

7. The method of claim 6, wherein the selecting an address mapping scheme further includes selecting a second scheme, in which the memory mapping bits sequentially increase according to an interleaving granularity and some of the memory mapping bits corresponding to some interleaving granularities are adjusted, if the information associated with the image and the interleaving satisfies a second condition.

8. The method of claim 7, wherein most significant bits of the memory mapping bits corresponding to the some interleaving granularities are inverted.

9. The method of claim 7, wherein the image is divided into a matrix format according to the interleaving granularity, and the some interleaving granularities correspond to even rows of the matrix format.

10. The method of claim 7, wherein the image is divided into a matrix format according to the interleaving granularity, and the some interleaving granularities correspond to even columns, of the matrix format.

11. The method of claim 1, wherein the information associated with the image and the interleaving includes a size of the image, a size of each of a plurality of tiles obtained by dividing the image, an interleaving granularity, and the number of the plurality of memories.

12. An address generator of an image processing device comprising:
an address mapping unit receives information of an image and outputs first memory addresses corresponding to a plurality of memories based on the input information of the image;
a memory mapping bit adjusting unit receives the memory addresses and outputs second memory addresses by adjusting memory mapping bits selecting one of the plurality of memories among the input memory addresses;
a checking unit receives the information of the image and information of interleaving for dispersedly storing the image at the plurality of memories and outputs a selection signal based on the input information of the image and the information of interleaving; and
a multiplexer outputs one of the first memory addresses and the second memory addresses in response to the selection signal.

13. The address generator of claim 12, wherein the memory mapping bit adjusting unit inverts a most significant bit of the memory mapping bits.

14. The address generator of claim 12, wherein the information of the image includes a size of the image and a size of each of tiles generated by dividing the image.

15. The address generator of claim 12, wherein the information of interleaving includes an interleaving granularity and the number of the plurality of memories.

16. A method of storing an image into a plurality of memories comprises:
determining a number of portions a row or column of the image is to be divided into, wherein each portion is a tile of the image;
selecting one of a first address mapping scheme and a second address mapping scheme based on the determined number;
dividing the entire image into units of the tiles; and
storing each tile into a selected one of the memories based on the selected address mapping scheme.

17. The method of claim 16, wherein when the first address mapping scheme is selected, the storing comprises copying each tile in each row or column of the image into a different sequential one of the memories.

18. The method of claim 16, wherein when the second address scheme is selected, the storing comprises copying each tile in each odd row or column of the image into a different sequential one of the memories and copying each file in each even row or column of the image into a non-sequential one of the memories.

19. The method of claim 16, wherein each tile has an associated address and the storing comprises:
selecting one of the memories based on a mapping bit of the address; and
copying the tile into the selected memory.

20. The method of claim 19, wherein values of the mapping bits of at least two of the tiles are different from one another, and each different value corresponds to a different one of the memories.
